(19) United States
(12) Patent Application Publication
(10) Pub. No.: US 2021/0102390 A1
(43) Pub. Date: Apr. 8, 2021

(54) PORTABLE DAVIT

(71) Applicant: GLOBAL BMU ACCESS TECHNOLOGIES, LLC, New York, NY (US)

(72) Inventors: John McDermott, E. Setauket, NY (US); Martin Wunder, Waltrop (DE)

(73) Assignee: GLOBAL BMU ACCESS TECHNOLOGIES, LLC, New York, NY (US)

(21) Appl. No.: 16/593,135

(22) Filed: Oct. 4, 2019

(51) Int. Cl. E04G 3/32

(52) U.S. Cl. CPC E04G 3/32; E04G 2003/286

(57) ABSTRACT

A portable davit includes a base having a mounting portion and a housing coupled to the mounting portion. The housing include an inner surface defining a cavity. A hoist is positioned within the cavity. The hoist includes a drive and a rope. The rope includes opposite first and second ends. The first end of the rope is wound about the drive. A mast includes opposite first and second ends. The first end of the mast is positioned within the cavity. The mast includes an inner surface defining a passageway. A jib includes opposite first and second ends. The first end of the jib is coupled to the second end of the mast. The second end of the rope extends through an opening in the second end of the jib.

### TECHNICAL FIELD

The present disclosure generally relates to davits, and more particularly to portable davits for supporting, raising and lowering scaffolds. Methods of producing and using the improved portable davits are provided.

### BACKGROUND

The construction and maintenance of multi-story buildings, such as high-rise office and residential buildings is accomplished through the use of scaffolds. Some multi-story buildings include beams that extend from a roof of the building. The beams support the scaffolds, which are used by masons, glaziers, window washers and similar building repair and maintenance personnel to maintain the building. Winches include a cable or rope that is attached to a frame of the scaffold and to the beam on the roof. The winches may be manually operated or may be powered by electricity to raise or lower the scaffold to a selected level. The scaffolds must be sufficiently rigid and strong to ensure that the scaffold will not collapse or fall apart. Various government codes and regulations mandate that davits and scaffolds be able to meet certain safety standards with respect to strength, durability and failure resistance.

Conventional scaffold davits have become unduly heavy, complex and cumbersome in order to meet increasingly stringent safety standards. For example, some conventional scaffold davits have attempted to satisfy certain safety standards by constructing the scaffolds from large, strong components which also have a great deal of weight. These heavy davits require significant labor to assemble, disassemble and transport. Accordingly, conventional scaffold davits are assembled at a point of use, used over a finite period of time, are disassembled and stored, and are then reassembled at the same point of use. As such, one scaffold davit is typically required at each point of use. Because some buildings include many points of use, many scaffold davits will thus often be required to perform work and/or maintenance on just one building. Prior scaffold davits tend to be heavy, cumbersome structures that are labor intensive to assemble and to disassemble. They utilize components that provide structural rigidity at the expense of increased weight. This disclosure describes an improvement over these prior art technologies.

### SUMMARY

In one embodiment, in accordance with the principles of the present disclosure, a portable davit comprises a base having a mounting portion and a housing coupled to the mounting portion. The housing comprises an inner surface defining a cavity. A hoist is positioned within the cavity. The hoist comprises a drive and a rope. The rope includes opposite first and second ends. The first end of the rope is wound about the drive. A mast comprises opposite first and second ends. The first end of the mast is positioned within the cavity. The mast comprises an inner surface defining a passageway. A jib includes opposite first and second end. The first end of the jib is coupled to the second end of the mast. The second end of the rope extends through an opening in the second end of the jib.

In one embodiment, in accordance with the principles of the present disclosure, a portable scaffold davit comprises a base having a mounting portion and a housing coupled to the mounting portion, the housing comprising an inner surface defining a cavity. A first bracket is coupled to the base. A hoist is positioned within the cavity. The hoist comprises a drive and a rope. The rope includes opposite first and second ends. The first end of the rope is wound about the drive. A sleeve is positioned within the cavity. A second bracket is coupled to the sleeve. A mast includes opposite first and second ends. The first end of the mast is coupled to the sleeve. The mast comprises an inner surface defining a passageway. A jib includes opposite first and second ends. The first end of the jib is coupled to the second end of the mast. The second end of the rope extends through an opening in the second end of the jib. A pin extends through the first bracket and the second bracket. The pin defines a hinge configured to allow the mast to pivot relative to the base.

In one embodiment, in accordance with the principles of the present disclosure, a portable scaffold davit comprises a a base comprising a mounting portion and a housing coupled to the mounting portion. The housing comprises an inner surface defining a cavity. A drum hoist is removably positioned within the cavity. The drum hoist comprises a drive and a rope. The rope includes opposite first and second ends. The first end of the rope is wound about the drive. A mast includes opposite first and second ends. The first end of the mast is positioned within the cavity. The mast comprises an inner surface defining a passageway. The mast is pivotable relative to the base about a hinge between a first orientation in which the mast extends parallel to the base and a second orientation in which the mast extends transverse to the base. A jib includes opposite first and second ends defining a length of the jib. The first end of the jib is coupled to the second end of the mast. The second end of the rope extends through an opening in the second end of the jib. The jib comprises a screw system configured to increase and decrease the length of the jib. The jib is pivotable relative to the mast between a first orientation in which the jib extends transverse to the mast and a second orientation in which the jib extends parallel to the mast. The second end of the rope is coupled to a platform. The mast and the jib are made from carbon fiber.

### BRIEF DESCRIPTION OF THE DRAWINGS

The present disclosure will become more readily apparent from the specific description accompanied by the following drawings, in which:

FIG. 1 is a side view, in part cross-section, of one embodiment of a portable davit system, in accordance with the principles of the present disclosure;

FIG. 2 is an enlarged view of a section of the portable davit system shown in FIG. 1;

FIG. 3 is a perspective view, in part phantom, of components of the portable davit system shown in FIG. 1;

FIG. 4 is a perspective view of components of the portable davit system shown in FIG. 1;

FIG. 5 is an enlarged side view of components of the portable davit system shown in FIG. 1;

FIG. 6 is an enlarged perspective view, in part phantom, of components of the portable davit system shown in FIG. 1;

FIG. 7 is an enlarged perspective view, in part phantom, of components of the portable davit system shown in FIG. 1;

FIG. 8 is an enlarged perspective view, in part phantom, of components of the portable davit system shown in FIG. 1;

FIG. 9 is a perspective view of a component of the portable davit system shown in FIG. 1;

FIG. 10 is a perspective view of a component of the portable davit system shown in FIG. 1;

FIG. 11 is a perspective view, in part phantom, of components of the portable davit system shown in FIG. 1;

FIG. 12 is a perspective view, in part phantom, of components of the portable davit system shown in FIG. 1;

FIG. 13 is a perspective view, in part phantom, of components of the portable davit system shown in FIG. 1;

FIG. 14 is a perspective view, in part phantom, of components of the portable davit system shown in FIG. 1;

FIG. 15 is a perspective view of components of the portable davit system shown in FIG. 1;

FIG. 16 is a perspective view, in part phantom, of components of the portable davit system shown in FIG. 1;

FIG. 17 is a perspective view of components of the portable davit system shown in FIG. 1;

FIG. 18 is a perspective view, in part phantom, of components of the portable davit system shown in FIG. 1;

FIG. 19 is a perspective view, in part phantom, of components of the portable davit system shown in FIG. 1;

FIG. 20 is a perspective view, in part phantom, of components of the portable davit system shown in FIG. 1;

FIG. 21 is a perspective view, in part phantom, of components of the portable davit system shown in FIG. 1;

FIG. 22 is a perspective view, in part phantom, of components of the portable davit system shown in FIG. 1;

FIG. 23 is a perspective view, in part phantom, of components of the portable davit system shown in FIG. 1;

FIG. 24 is a perspective view, in part phantom, of components of the portable davit system shown in FIG. 1;

FIG. 25 is a perspective view, in part phantom, of components of the portable davit system shown in FIG. 1;

FIG. 26 is a perspective view, in part phantom, of components of one embodiment of the portable davit system shown in FIG. 1, in accordance with the principles of the present disclosure;

FIG. 27 is a perspective view of components of one embodiment of the portable davit system shown in FIG. 1, in accordance with the principles of the present disclosure; and

FIG. 28 is a perspective view of components of one embodiment of the portable davit system shown in FIG. 1, in accordance with the principles of the present disclosure.

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

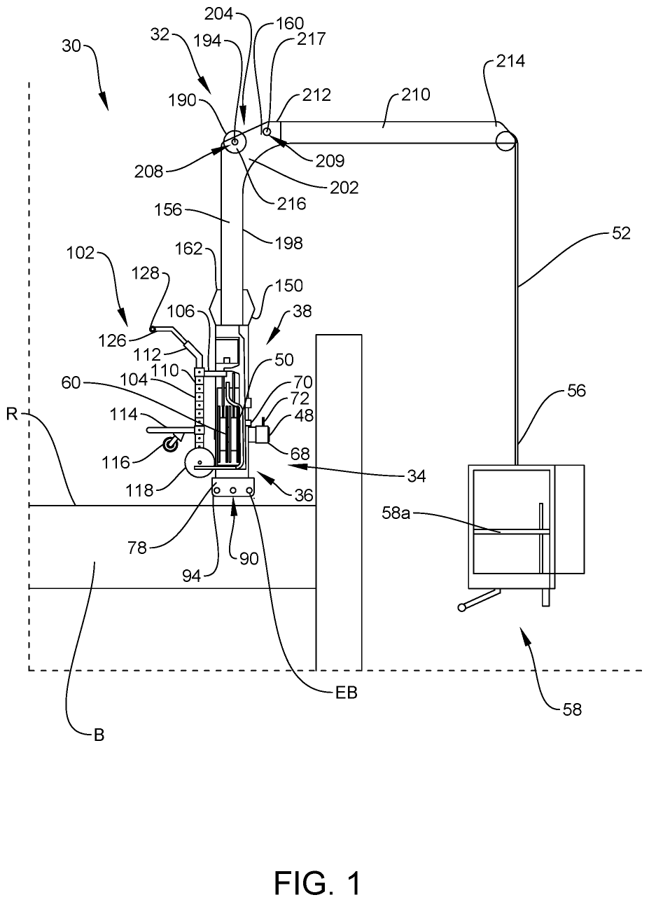

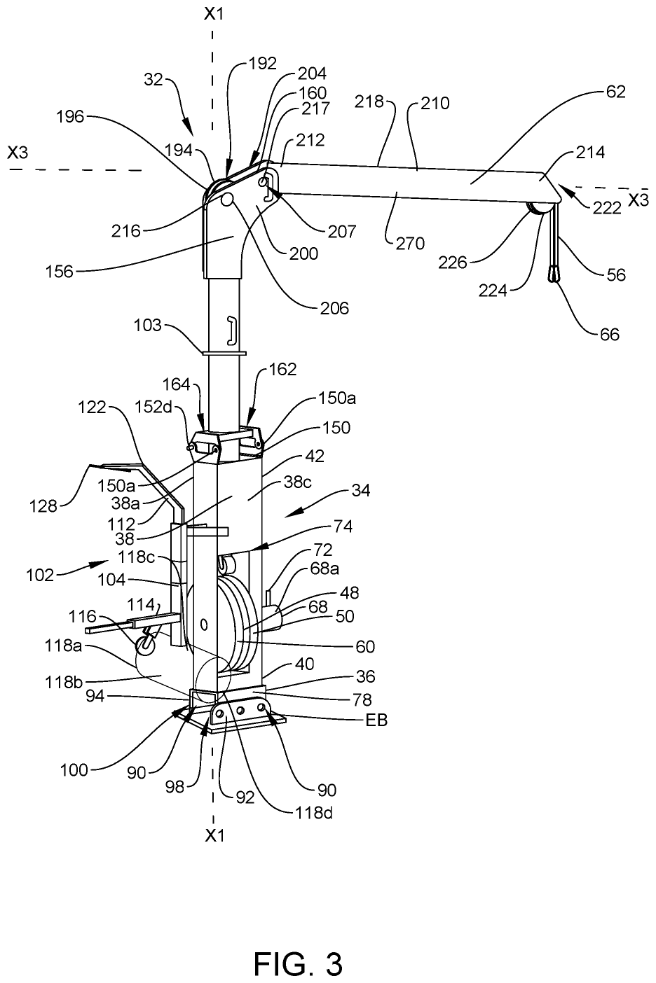

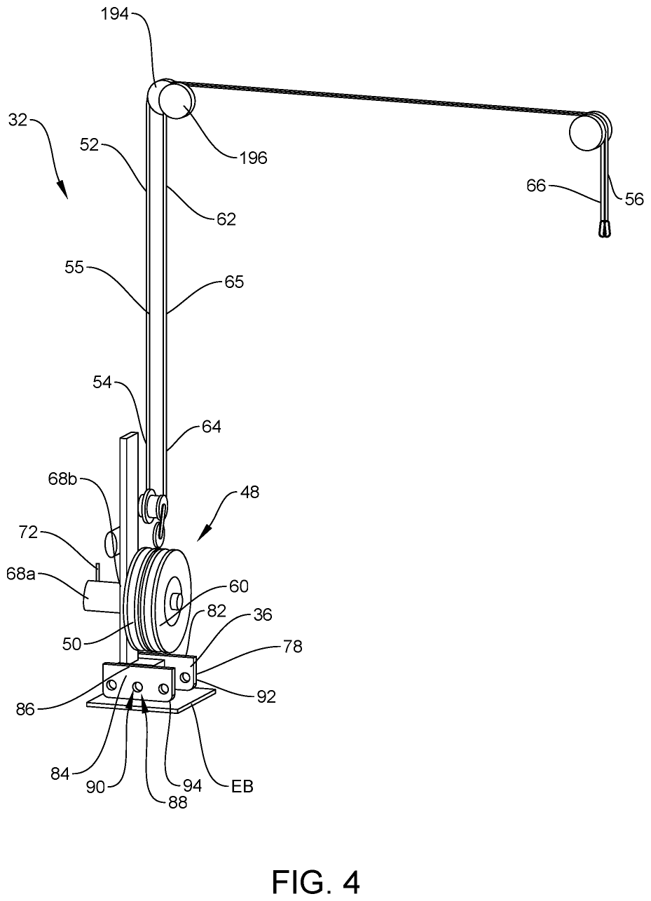

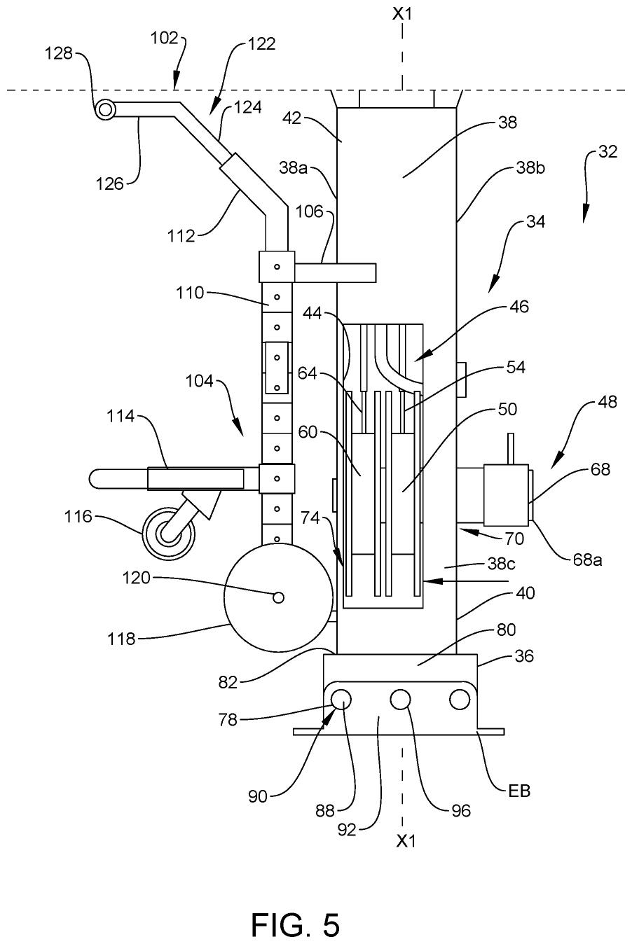

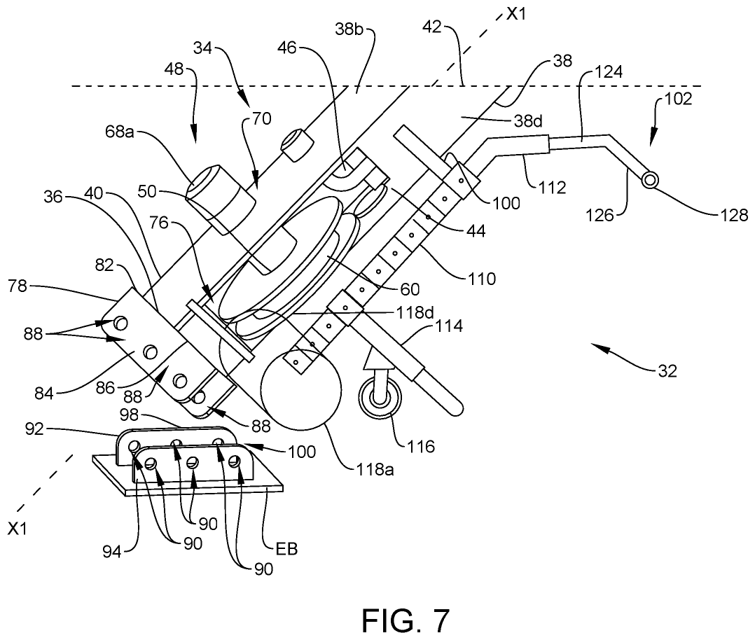

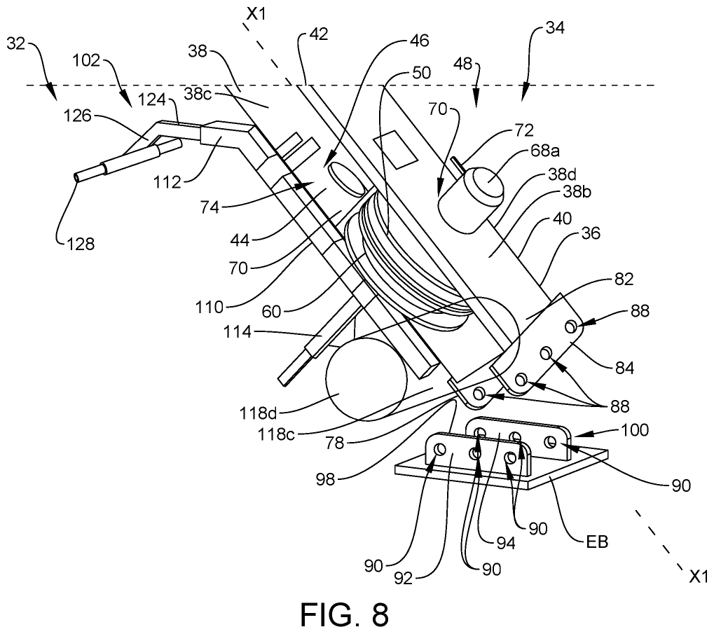

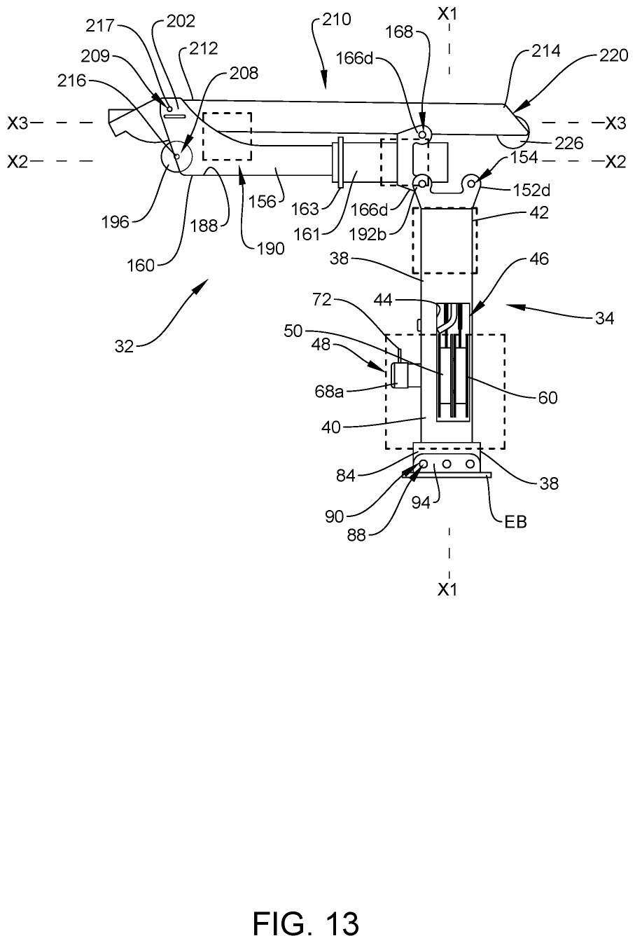

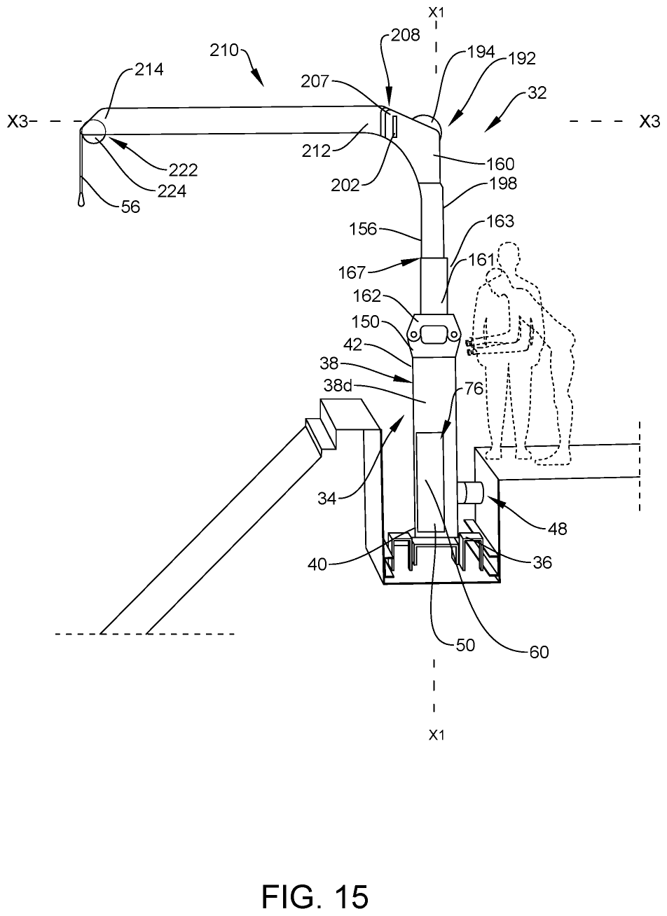

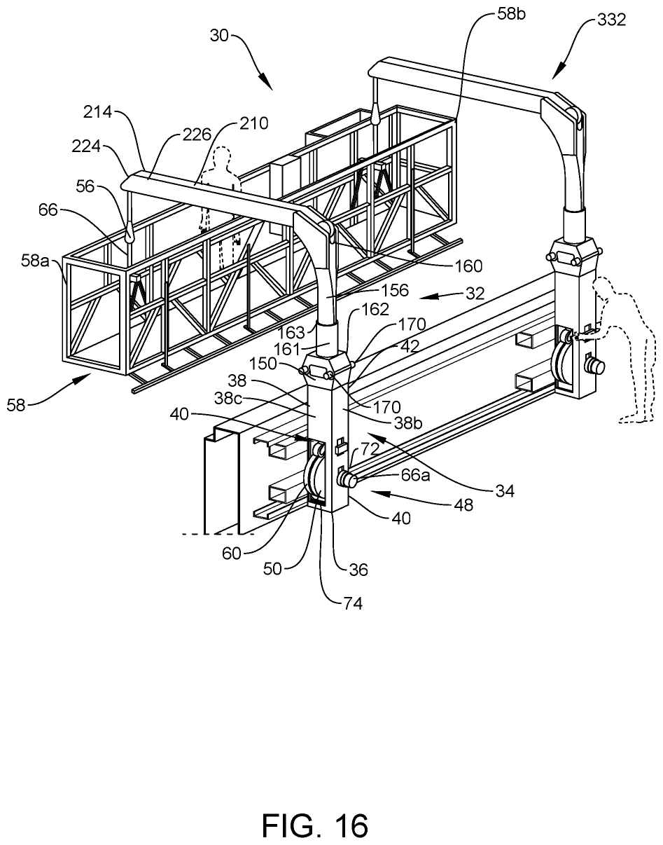

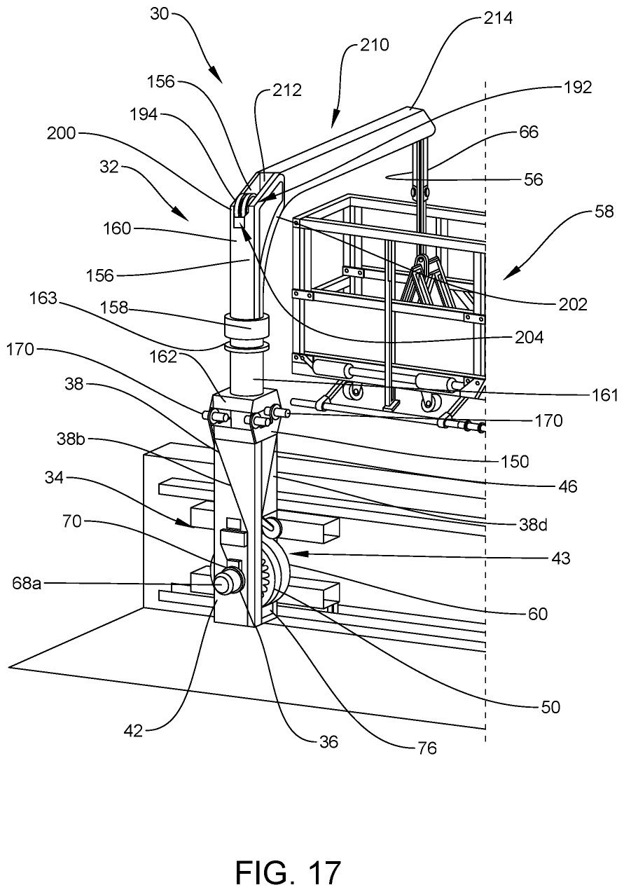

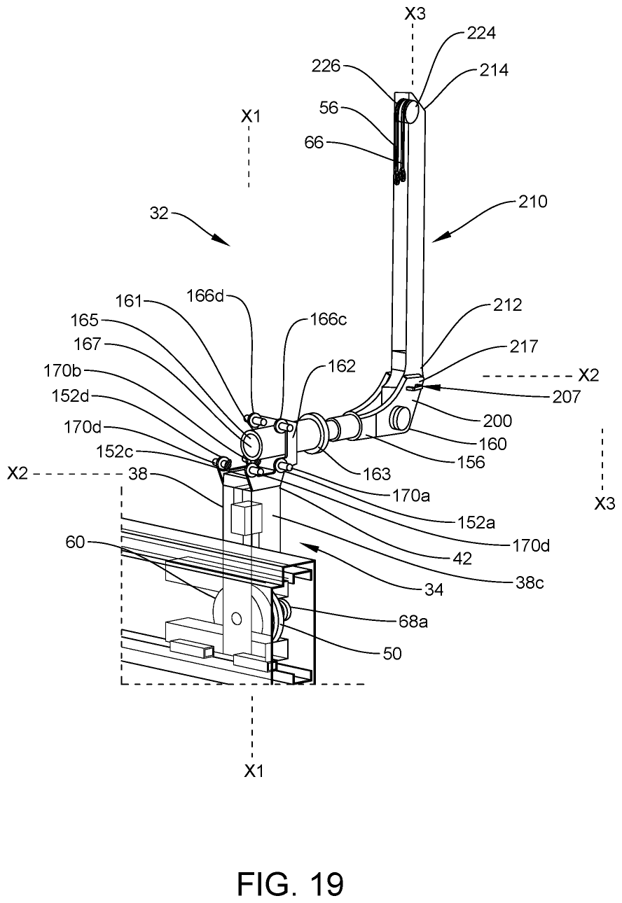

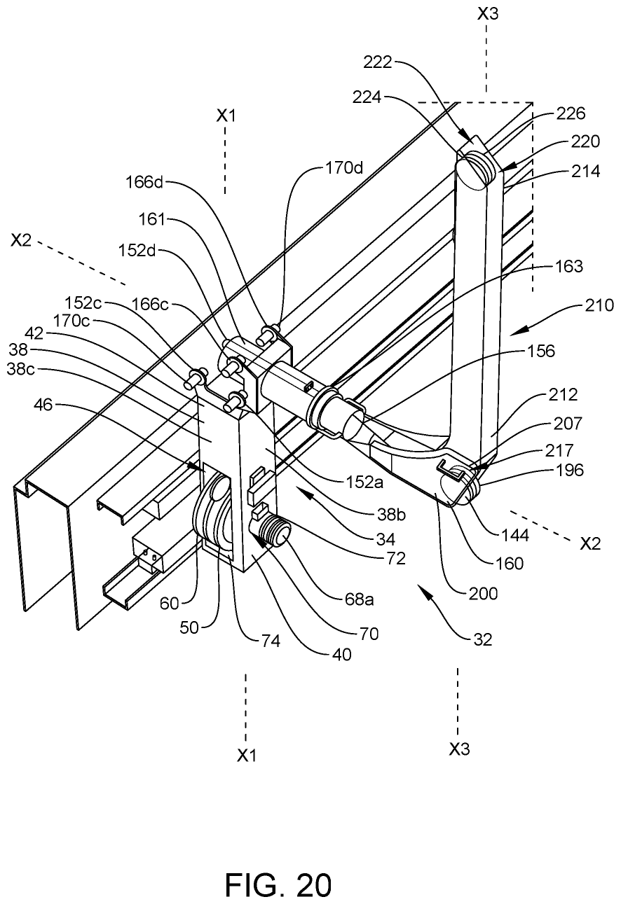

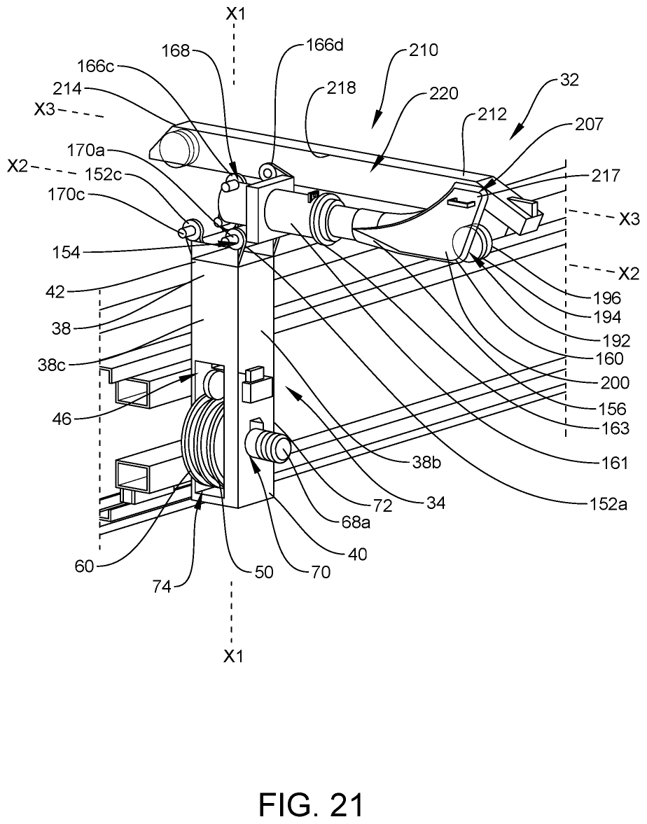

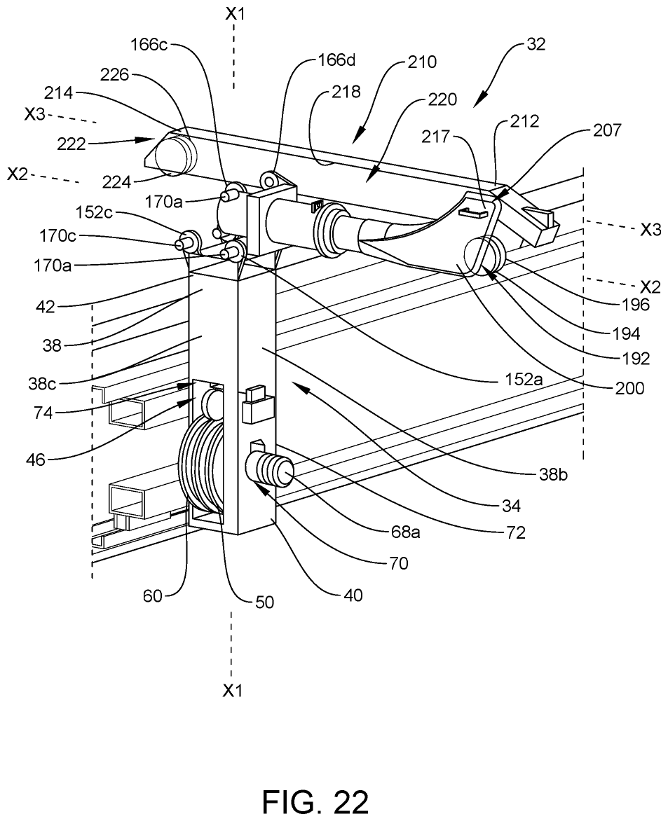

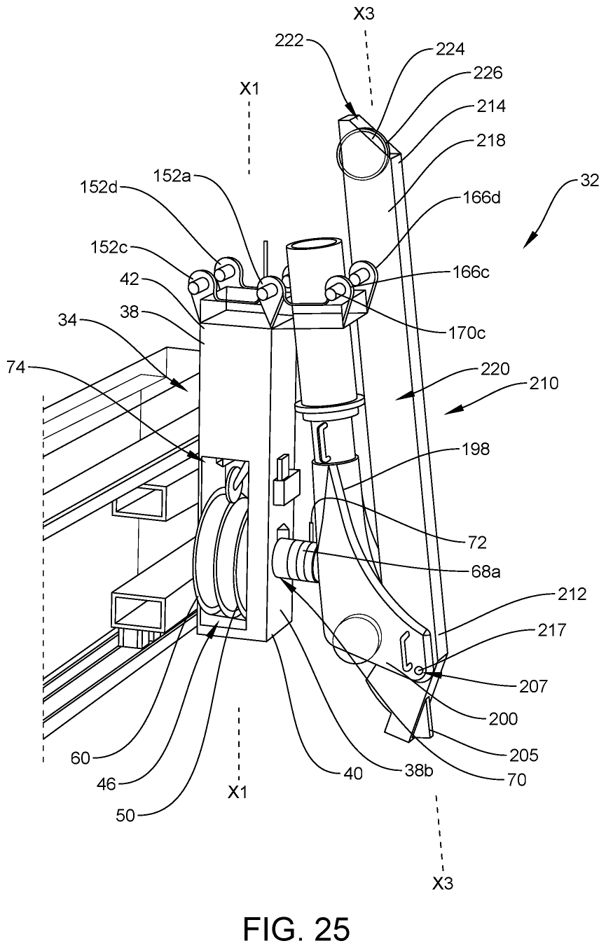

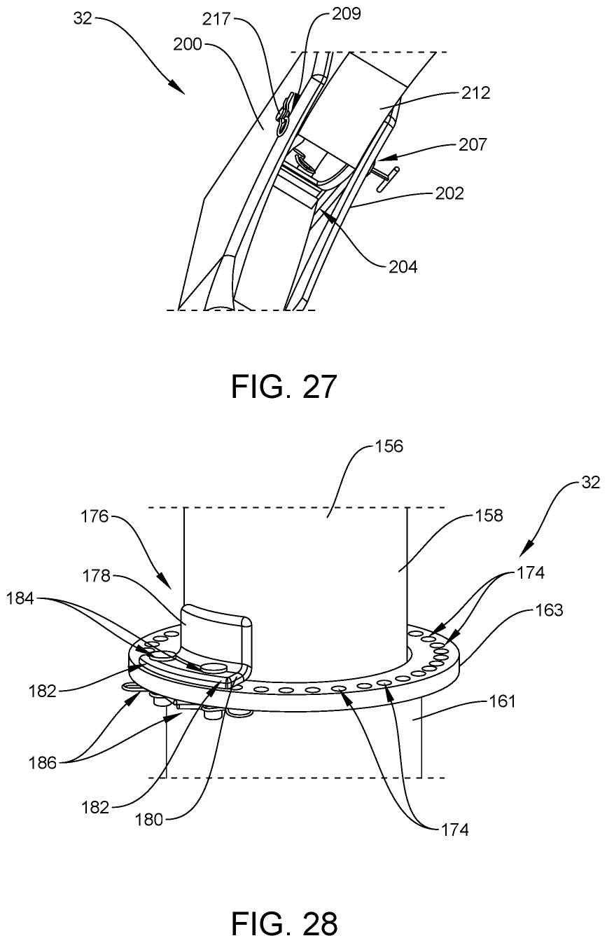

The following discussion includes a description of a portable scaffold davit, related components and methods of using the portable scaffold davit, in accordance with the principles of the present disclosure. Alternate embodiments are also disclosed. Reference will now be made in detail to the exemplary embodiments of the present disclosure, which are illustrated in the accompanying figures. Turning to FIGS. 1-28, there is illustrated components of a portable scaffold davit system 30.

The components of portable scaffold davit system 30 can be fabricated from materials including metals, polymers and/or composites, depending on the particular application. For example, the components of portable scaffold davit system 30, individually or collectively, can be fabricated from materials such as carbon fiber, fiberglass, aluminum, steel, iron, stainless steel, titanium, titanium alloys, cobalt-chrome, stainless steel alloys, semi-rigid and rigid materials, plastics, elastomers, rubbers and/or rigid polymers. Various components of portable scaffold davit system 30 may have material composites, including the above materials, to achieve various desired characteristics such as weight, strength, rigidity, elasticity, performance and durability. The components of portable scaffold davit system 30, individually or collectively, may also be fabricated from a heterogeneous material such as a combination of two or more of the above-described materials. The components of portable scaffold davit system 30 can be extruded, molded, injection molded, cast, pressed and/or machined. The components of portable scaffold davit system 30 may be monolithically formed, integrally connected or include fastening elements and/or instruments, as described herein.

In some embodiments, portable scaffold davit system 30 includes a hoisting davit made from lightweight materials, such as, for example, carbon fiber to allow for the transfer of portable scaffold davit system 30 from roof to roof using only two workers, while not exceeding government or agency guidelines for personnel manual lifting limits. In some embodiments, the boom/jib and mast are carbon fiber to keep weight manageable. Because the hoist(s)s remains on the roof, the suspended platform or single man basket are lighter and therefor can have a higher Safe Working Load (SWL), while maintaining higher safety factors on the structural components and suspension cables. In some embodiments, the hoisting davit of portable scaffold davit system 30 includes a foldable mast to provide for portability as well as safer operation and storage versus davit systems the require that the mast and boom/jib be separated manually. In some embodiments, the hoist davit of portable scaffold davit system 30 does not include a truss between the mast and the jib to allow for greater variation of travel along the jib, such as, for example, within a boom trolley of the jib, as discussed herein. In some embodiments, the boom/jib of the hoist davit of portable scaffold davit 30 can be extended or retracted to adjust the outreach. The added outreach to weight ratio will allow previously permanent davits to be portable. In some embodiments, the hoisting davit of portable scaffold davit system 30 is configured to replace various types of davits, such as, for example, 1,000 lbs. davits, 1,150 lbs. davits and/or 1,250 lbs. davits. In some embodiments, the hoisting davit of portable scaffold davit system 30 is configured to replace various types of davits without replacing the existing bases/mounting brackets on the building.

In some embodiments, portable scaffold davit system 30 is configured to maintain a continuous and redundant steel connection to the building structure because the steel wire ropes travel through the mast and terminate on the steel winch drum, which is secured to the steel hoist frame, which is secured to the steel davit base, which is secured to the building structure. That is, unlike conventional davits, portable scaffold davit system 30 does not rely on the davit medium (aluminum or other) as an intermediary in connection to the building.

In some embodiments, portable scaffold davit system 30 allows for emergency rescue operation from the roof. That is, unlike conventional davit systems that rely on self-powered platforms, where the hoists (traction or winch) are on the suspended platform, portable scaffold davit system 30 includes a winch within the davit itself to allow for rescue and auxiliary operation from the roof, such as lowering via a controlled descent device, or raising with a hand drill. Portable scaffold davit system 30 thus provides an advantage over current davit systems, which employ self-powered platforms that require emergency outboard rescue such as removal of windows to access stranded or disabled personnel on the platform.

In some embodiments, portable scaffold davit system 30 includes a winch within a base of the hoist davit, wherein the winch can include a drum hoist or a traction hoist. That is, the hoist is integrated with the base of the hoist davit. In some embodiments, the hoist davit of portable scaffold davit system 30 includes a foldable carbon fiber jib. In some embodiments, portable scaffold davit system 30 positions heavy parts close to the ground and lightweight parts on top in a manner that provides extreme low center of mass for safe maneuvering on the roof. In some embodiments, the hoist davit of portable scaffold davit system 30 is configured to be connected to conventional davit bases. In some embodiments, the hoist davit of portable scaffold davit system 30 is lowered and raised onto the conventional davit base.

Portable scaffold davit system 30 includes a davit, such as, for example, a hoist davit 32 having a base 34 comprising a mounting portion 36 and a housing 38 coupled to mounting portion 36. In some embodiments, housing 38 can be variously coupled to mounting portion by threads, mutual grooves, screws, adhesive, nails, barbs, raised elements, spikes, clips, snaps, friction fittings, compressive fittings, expanding rivets, staples, fixation plates, key/keyslot, tongue in groove, dovetail, magnetic connection and/or posts. Mounting portion 36 is configured to be coupled to an existing bracket of a building, such as, for example, an existing bracket EB on a roof R of a building B to couple davit 32 to building B, as discussed herein. Housing 38 extends along a longitudinal axis X1 between an end 40 and an opposite end 42. End 40 is coupled directly to mounting portion 36. An inner surface 44 of housing 38 defines a cavity 46. In some embodiments, cavity 46 may have various cross section configurations, such as, for example, circular, oval, oblong, triangular, rectangular, square, polygonal, irregular, uniform, non-uniform, variable, tubular and/or tapered. In some embodiments, all or a portion of base 34 is made from a strong, lightweight material, such as, for example, carbon fiber. That is, all or a portion of base 34 consists of and/or comprises a strong, lightweight material, such as, for example, carbon fiber. In some embodiments, existing base EB and/or all or a portion of base 34, such as, for example, housing 38 is made from steel and/or aluminum. In one particular embodiment, all or a portion of housing 38 consists of and/or comprises a strong, lightweight material, such as, for example, carbon fiber and all or a portion of housing 38 consists of and/or comprises steel and/or aluminum

At least a portion of a winch, such as, for example, a hoist 48 is positioned within cavity 46 such that hoist 48 is integral with housing 38. Hoist 48 comprises a drive 50 and a rope, such as, for example, steel wire rope 52. Rope includes an end 54 and an opposite end 56. End 54 is wound about drive 50 and end 56 is configured to be coupled to a scaffold, such as, for example, a platform 58 of portable scaffold davit system 30. Rotation of drive 50 relative to housing 38 raises and lowers platform 58 relative to roof R of building B, as discussed herein. In some embodiments, hoist 48 includes only one drive and only one rope. In some embodiments, hoist 48 includes a drive 60 in addition to drive 50 and a rope, such as, for example, a steel wire rope 62 in addition to rope 52. In some embodiments, drive 60 is coupled to drive 60 such that rotation of drive 50 relative to housing 38 in a first rotational direction also rotates drive 60 relative to housing 38 in the first rotational direction and rotation of drive 50 relative to housing 38 in an opposite second rotational direction also rotates drive 60 relative to housing 38 in the second rotational direction. Rope 62 includes an end 64 and an opposite end 66. End 64 is wound about drive 60 and end 66 is coupled to platform 58. Drive 50, 60 are configured to rotate simultaneously relative to housing 38 to raise and lower platform 58 relative to roof R of building B, as discussed herein. In some embodiments, drives 50, 60 are made of steel.

Housing 38 includes opposite walls 38a, 38b and opposite walls 38c, 38d that each extend from wall 38a to wall 38b. Hoist 48 comprises a motor shaft 68 having an end 68a that extends through an opening 70 in wall 38b and an opposite end 68b that is positioned within cavity 46 and coupled to drive 50. Motor shaft 58 is configured to simultaneously rotate drives 50, 60 relative to housing 38 to raise and lower platform 58 relative to roof R of building B. In some embodiments, motor shaft 68 is configured to be rotated either electronically or manually. It is envisioned that manual rotation of motor shaft 68 relative to housing 38 may be utilized for rescue to a roof, such as, for example, roof R. That is, because end 68a of motor shaft 68 is positioned outside of cavity 46, end 68a is easily accessible for engagement with a tool to grip and rotate motor shaft 68 relative to housing to raise or lower platform 58 relative to roof R of building B in the event electronic operation of winch 48 fails or some other emergency situation arises. In some embodiments, a break lever 72 is coupled to motor shaft 68. Lever 72 is configured to allow drives 50, 60 to each rotate freely relative to housing 68 to allow platform 58 to move to the ground, as discussed herein. A portion of drive 50 and a portion of drive 60 each extend through a window 74 in wall 38c and an opposite portion of drive 50 and an opposite portion of drive 60 each extend through a window 76 in wall 38d. This provides access to drives 50, 60 for maintenance or an emergency situation, for example, on opposite sides of housing 38. Opening 70 and windows 74, 76 are each in communication with cavity 46. In some embodiments, wall 38a extends parallel to wall 38b and wall 38c extends parallel to wall 38d. In some embodiments, wall 38a, wall 38b, wall 38c and/or wall 38d may be disposed at alternate orientations, relative to axis X1, such as, for example, transverse, perpendicular and/or other angular orientations such as acute or obtuse, co-axial and/or may be offset or staggered. In some embodiments, opening 70, window 74 and/or window 76 may be variously shaped, such as, for example, circular, oval, oblong, triangular, square, polygonal, irregular, uniform, non-uniform, offset, staggered, undulating, arcuate, variable and/or tapered.

In some embodiments, mounting portion 36 includes a flange 78 extending from a side 80 of a body 82 of mounting portion 36 and a flange 84 extending from an opposite side 86 of body 84. Flanges 78, 84 each include one or a plurality of apertures 88. Apertures 88 are each configured for alignment with a hole 90 of spaced apart flanges 92, 94 of existing bracket EB. Davit 32 comprises one or a plurality of pegs 96. In some embodiments, pegs 96 are each configured to extend simultaneously through one of apertures 88 and one of holes 90 to fix base 34 to existing bracket EB. In some embodiments, flange 92 includes a channel 98 configured for disposal of flange 88 and flange 94 includes a channel 100 configured for disposal of flange 84. For example, flange 78 can be disposed in channel 98 and flange 84 can be disposed in channel 100 to align apertures 88 with holes 90 such that pegs 96 can simultaneously be inserted through one of apertures 88 and one of holes 90 to fix base 34 to existing bracket EB. In some embodiments, flanges 78, 84 extend parallel to one another. In some embodiments, pegs 96 are fasteners, such as, for example, threaded bolts and system 30 includes threaded nuts that are configured to mate with the threaded bolts to fix base 34 to existing bracket EB. In some embodiments, at least a portion of mounting portion 36, such as, for example, body 82 and/or flanges 78, 84 are made from aluminum and/or steel to provide improved shock and impact resistance versus mounting portions that are made from lighter materials, such as, for example, fiber carbon or fiber glass.

In some embodiments, system 30 includes a transport assembly 102 comprising a frame 104 having a rail 106 that is fixed to base 34 such that rail extends perpendicular to axis X1. Frame 104 includes a rail 108 that is fixed to rail 106. Rail 108 includes a section 110 that extends parallel to axis X1 and a section 112 that extends transverse to axis X1. Section 112 extends from section 110. Frame 104 includes a rail 114 that extends from section 110 such that rail 114 extends perpendicular to axis X1. A wheel 116 is rotatably coupled to rail 114. One or a plurality of wheels, such as, for example, transport wheels 118 are rotatably coupled to rail 110. In some embodiments, wheels 118 include first wheels 118a, 118b and second wheels 118c, 118d. Wheels 118a, 118b are positioned on a first side of rail 110 and wheels 118c, 118d are positioned on an opposite second side of rail 110 such that wheels 118a, 118b are spaced apart from wheels 118c, 118d by rail 110. An axle 120 extends through wheels 118a, 118b, 118c, 118d and rail 110 to connect wheels 118a, 118b, 118c, 118d with rail 110. Frame 104 includes a rail 122 that is fixed to section 112. Rail 122 includes a section 124 that extends transverse to axis X1 and a section 126 that extends perpendicular to axis X1. Section 124 extends from section 112. A handle 124 is fixed to section 126 such that handle 124 extends perpendicular to section 126. Handle 124 is configured to be gripped to transport davit 32 from one location to another location, as discussed herein. In some embodiments, rail 106, rail 114, rail 122, section 110, section 112, section 124 and/or section 126 may be disposed at alternate orientations, relative to axis X1, such as, for example, transverse, parallel, transverse, perpendicular and/or other angular orientations such as acute or obtuse, co-axial and/or may be offset or staggered.

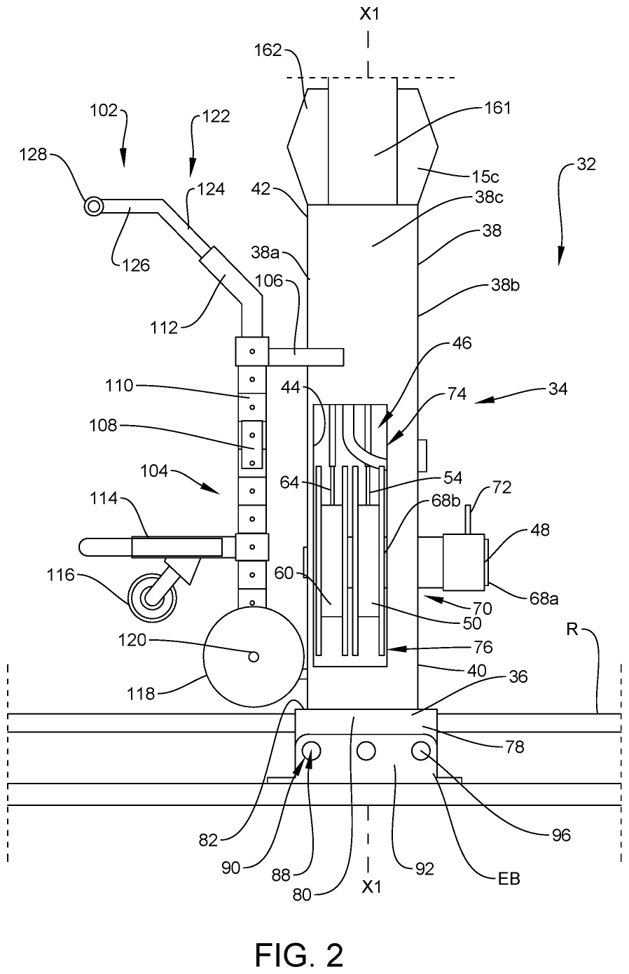

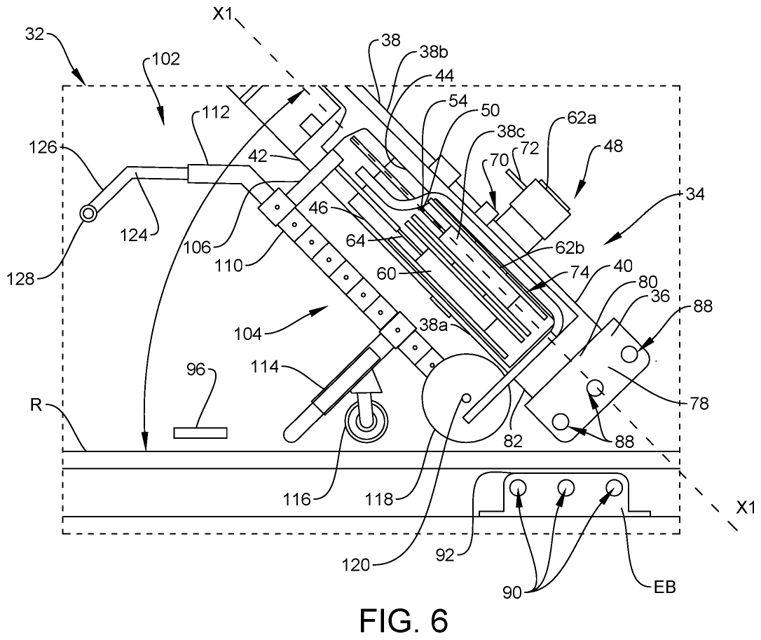

Wheels 116, 118 are configured to support base 34 while davit 32 is being assembled and unassembled and/or when davit 32 is being moved from one location to another location, such as, for example, one location on roof R to another location on roof R. For example, in one embodiment, base 34 can be connected with existing bracket EB by tilting base 34 such that axis X1 extends at an angle α relative to roof R, as shown in FIG. 6, and the majority of the weight of davit 32 is carried by wheels 116, 118. Wheels 116, 118 rotate relative to frame 104 to translate base 34 along roof R and position mounting portion 36 adjacent to existing base EB such that flange 78 is positioned within channel 98 and one of apertures 88 of flange 78 is aligned with one of holes 90 of flange 92. Two of apertures 88 of flange 78 are spaced apart from holes 90 of flange 92 such that only one aperture 88 of flange 78 is aligned with only one hole 90 of flange 92. One of pegs 96 is inserted into the aligned aperture 88 and hole 90 of flange 78 and flange 92. Mounting portion 36 is positioned relative to existing base EB such that flange 84 is positioned within channel 100 and one of apertures 88 of flange 84 is aligned with one of holes 90 of flange 94. Two of apertures 88 of flange 84 are spaced apart from holes 90 of flange 94 such that only one aperture 88 of flange 84 is aligned with only one hole 90 of flange 94. One of pegs 96 is inserted into the aligned aperture 88 and hole 90 of flange 84 and flange 94. Base 34 is then tilted relative to existing bracket EB such that axis L1 extends perpendicular to roof R, as shown in FIG. 2, and apertures 88 of flange 88 are each aligned with one of holes 90 of flange 92 and apertures 88 of flange 84 are each aligned with one of holes 90 of flange 94. One of pegs 96 is inserted into each of the aligned apertures 88 and holes 90 of flange 78 and flange 92. One of pegs 96 is inserted into each of the aligned apertures 88 and hole 90 of flange 84 and flange 94. In some embodiments, angle α is an acute angle. In some embodiments, angle α is an angle between about 5 degrees and 75 degrees. In some embodiments, angle α is an acute angle. In some embodiments, angle α is an angle between about 10 degrees and 45 degrees.

In one embodiment, base 34 can be disconnected from existing bracket EB by removing all but one of pegs 96 from flanges 78, 92 and removing all but one of pegs 96 from flanges 84, 94. Base 34 is then rotated relative to existing bracket EB about the one peg 96 that is inserted through flanges 78, 92 and the one peg 96 that is inserted through flanges 84, 94 such that axis X1 extends at angle α relative to roof R, as shown in FIG. 6. The one remaining peg 96 is removed from flanges 78, 92 and the one remaining peg 96 is removed from flanges 84, 94 such that base 34 can be lifted out of channels 98, 100 and removed from existing bracket EB. Base 34 can then be translated along roof R using wheels 116, 118 to move base from existing bracket EB to another location on roof R, such as, for example, another existing base that is the same or similar to existing bracket EB.

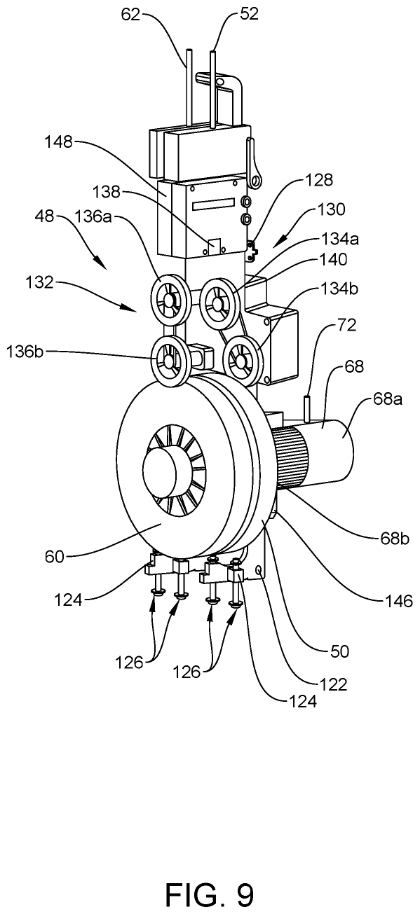

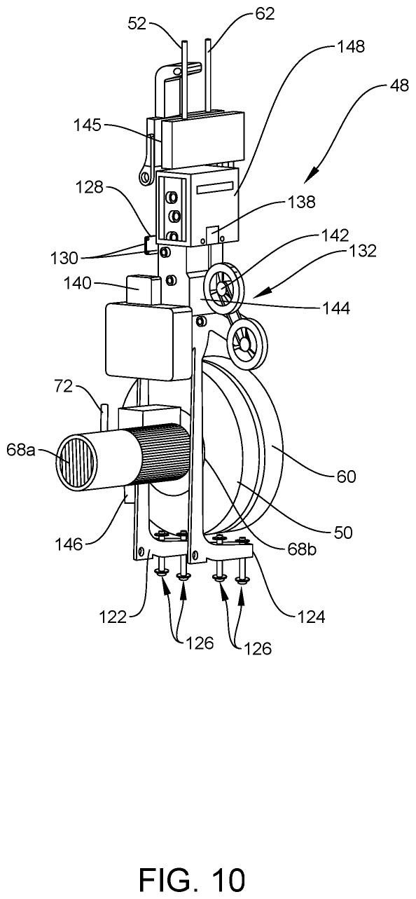

In some embodiments, hoist 48 is a traction hoist. In some embodiments, hoist 48 is a drum hoist, as shown in FIGS. 9 and 10, for example. As discussed above, hoist 48 includes ropes 52, 62. Ropes 52, 62 provide 50%-50% load distribution to eliminate rope jam. Drives 50, 60 provide hoist 48 with an electrically powered twin grooved drum drive with differential configured to secure a permanent wire rope load distribution (50%-50%). In some embodiments, drives 50, 60 provide hoist 48 with a drum capacity of 160 meters or 90 meters. Hoist 48 includes a hoist frame 122 that incorporates all necessary equipment and safety devices to meet and exceed the EN 1808 Standard such that no additional stirrup is required. Hoist 48 includes a pair of spaced apart lower brackets 124 and a plurality of fasteners 126 that are configured to couple hoist frame 122 to base 34. In one embodiment, fasteners 126 each extend through one of brackets 124 and into platform 110 to couple hoist frame 122 to base 34. Hoist 48 includes an upper bracket 128 and a plurality of fasteners 130 that are configured to couple hoist frame 122 to base 34. In one embodiment, fasteners 126 each extend through a wall of housing 38, such as, for example, wall 38a and into brackets 128 to couple hoist frame 122 to base 34. Hoist 48 includes an automatic rope layering system 132 to avoid the jumping of ropes 52, 62. Automatic rope layering system 132 includes pulleys 134a, 134b, 136a, 136b. Rope 52 is fed through pulleys 134a, 134b and rope 62 is fed through pulleys 136a, 136b. Positioning rope 52 through pulleys 134a, 134b prevents rope from jumping from drive 50 to drive 60. Likewise, positioning rope 62 through pulleys 136a, 136b prevents ropes from jumping from drive 60 to drive 50. Hoist 48 includes a fall-arrest device 138 having an emergency brake on each of ropes 52, 62 and a shock absorber configured to provide a shock-load factor of less than two. Hoist 48 includes only one multi-pin plug 140 that is configured to be fitted to a terminal box such that all wiring of hoist 48 is integrated. Hoist 48 includes a sensor 142 configured to detect the amount of load on drives 50, 60 and a sensor 144 configured to measure the amount of slack in ropes 52, 62. Hoist 48 includes a hand-wheel 146 configured to manually rotate drives 50, 60 without motor 68. Hoist 48 includes a built-in electrical and mechanical anti-tilt and emergency stop device 148 configured to maintain ropes 52, 62 in a parallel relationship to axis X1 and to stop motor shaft 68 from rotating drives 50, 60. Hoist 48 includes a top and ultimate limit switch 145 configured to prevent ropes 52, 62 from completely unwinding from drives 50, 60. In some embodiments, hoist 48 is a Synchrowinch SW 500 model drum hoist manufactured by Plumetazz S.A. of Bex, Switzerland.

Base 34 includes a bracket 150 coupled to end 42 of housing 38. Bracket 150 includes spaced apart extensions 152a, 152b, 152c, 152d. Extensions 152a, 152b, 152c, 152d each include a bore 154. Bracket 150 is coupled to housing 38 such that bracket 150 is permanently fixed to housing 38. Davit 32 includes a mast 156 extending along a longitudinal axis X2 between an end 158 and an opposite end 160. Davit 32 includes a hollow sleeve 161 that is coupled to base 34. Sleeve 161 includes a collar 163 and an inner surface 165 that defines a passageway 167. Passageway 167 is in fluid communication with cavity 46. End 158 of mast 156 is positioned in passageway 167 such that end 158 extends beyond an end of sleeve 161 opposite collar 163 and mast 156 is rotatable relative to sleeve 161 about axis X2, as discussed herein. In some embodiments, collar 163 includes a plurality of spaced apart holes 174 disposed radially about collar 163 and mast 156 includes a mount 176 that is permanently fixed to an outer surface of mast 156, as best shown in FIG. 28. Mount 176 includes a body 178 and a flange 180 that extends from body 178. Flange 178 includes one or a plurality of holes 182. Holes 182 are each configured to be aligned with one of holes 174 such that a plug 184 can be inserted simultaneously through one of holes 182 and one of holes 174 to prevent rotation of mast 156 relative to sleeve 161 about axis X2. Once plugs 184 are removed from holes 174, 182, mast 156 is able to rotate relative to sleeve 161 about axis X2. In some embodiments, plugs 184 are each maintained in holes 174, 182 via a pin, such as, for example, a cotter pin 186 that extends through a body of plug 184. In some embodiments, mast 156 is able to rotate 360° relative to sleeve 161 about axis X2 when plugs 184 are removed from holes 174, 182. In some embodiments, passageway 167 may have various cross section configurations, such as, for example, circular, oval, oblong, triangular, rectangular, square, polygonal, irregular, uniform, non-uniform, variable, tubular and/or tapered.

A bracket 162 is coupled to sleeve 161. In particular, bracket 162 includes an opening 164 and sleeve 161 extends through opening 164 such that sleeve 161 is permanently fixed to bracket 162. Bracket 162 includes spaced apart extensions 166a, 166b, 166c, 166d. Extensions 166a, 166b, 166c, 166d each include a bore 168. Extension 152a is positioned adjacent to extension 166a such that bore 154 of extension 152a is aligned with bore 168 of extension 166a and extension 152b is positioned adjacent to extension 166b such that bore 154 of extension 152b is aligned with bore 168 of extension 166b. A pin, such as, for example, a dowel 170a is positioned through bore 154 of extension 152a and bore 168 of extension 166a and a dowel 170b is positioned through bore 154 of extension 152b and bore 168 of extension 166b such that brackets 150, 162 and dowels 170a, 170b form a hinge 172. Hinge 172 is configured to allow mast 156 and sleeve 161 to pivot relative to base 34 between a first orientation in which axis X1 is parallel and/or coaxial with axis X2 and a second orientation in which axis X2 extends transverse to axis X2, such as, for example, at an acute angle relative to axis X1. When mast 156 and sleeve 161 are in the first orientation, a dowel 170c can be positioned through bore 154 of extension 152c and bore 168 of extension 166c and a dowel 170d can be positioned through bore 154 of extension 152c and bore 168 of extension 166d to maintain mast 156 and sleeve 161 in the first orientation. In some embodiments, bracket 150 can be variously connected with housing 38 and/or bracket 162 can be variously connected with sleeve 161, such as, for example, monolithic, integral connection, frictional engagement, threaded engagement, mutual grooves, screws, adhesive, nails, barbs and/or raised element.

Mast 156 includes an inner surface 188 defining a passageway 190. End 160 includes an opening 192 that is in communication with passageway 190. Pulleys 194, 196 each have a first portion positioned in passageway 190 and a second portion that extends through opening 192. Pulleys 194, 196 are rotatable relative to mast 156 in opposite first and second directions. Rope 52 includes an intermediate portion 55 between end 54 and end 56 and rope 62 includes an intermediate portion 65 between end 64 and end 66. Sections of portions 55, 65 are each enclosed within passageway 190 such that rope 52 directly engages pulley 194 and rope 62 directly engages pulley 196. That is, surface 188 surrounds ropes 52, 62 360° about axis X2 along a maximum length of mast 156 defined by the distance from end 158 to end 160. Portions 55, 65 then exit passageway 190 through opening 192. In some embodiments, passageway 190 may have various cross section configurations, such as, for example, circular, oval, oblong, triangular, rectangular, square, polygonal, irregular, uniform, non-uniform, variable, tubular and/or tapered. In some embodiments, all or a portion of mast 156 and/or sleeve 161 is made from a strong, lightweight material, such as, for example, carbon fiber. That is, all or a portion of mast 156 and/or sleeve 161 consists of and/or comprises a strong, lightweight material, such as, for example, carbon fiber.

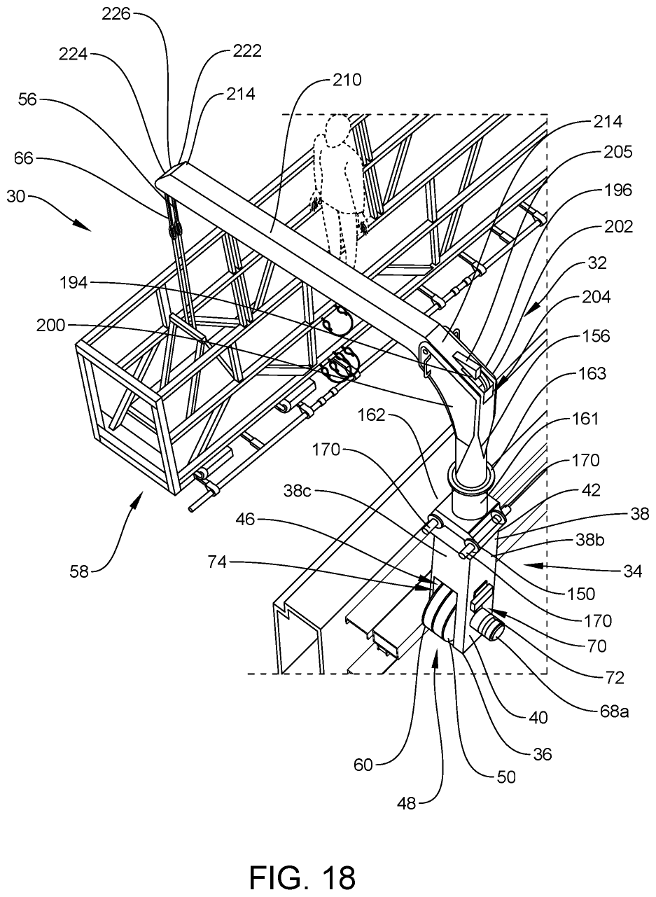

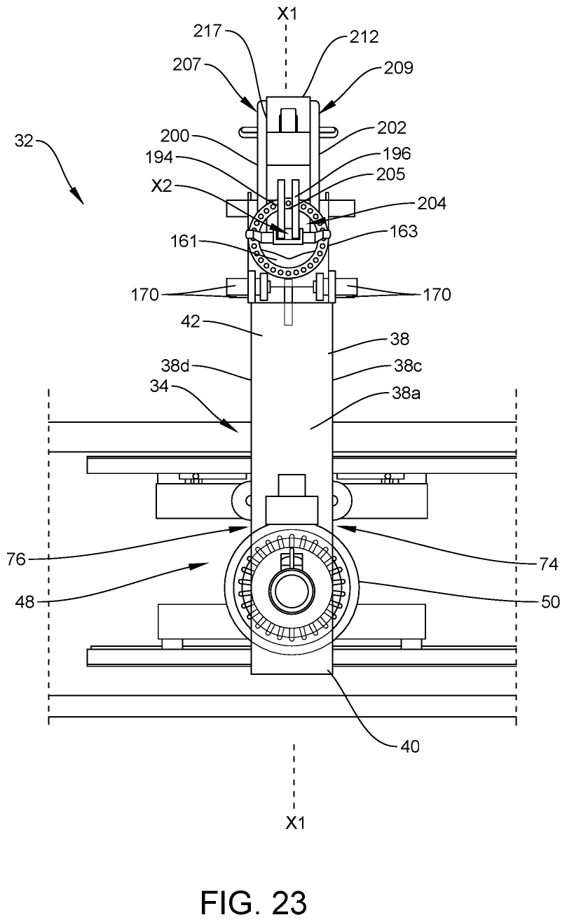

Mast 156 comprises a body 198 that includes surface 188 and passageway 190. End 160 includes spaced apart walls 200, 202 that each extend outwardly from body 198. Walls 200, 202 define a cavity 204 therebetween. Cavity 204 is in communication with opening 192. In some embodiments, wall 200 includes an aperture 206 and wall 202 includes an aperture 208 that is aligned with aperture 206. A dowel, such as, for example, a pin 216 extends through pulleys 194, 196 and apertures 206, 208 such that pulleys 194, 196 are rotatable relative to body and walls 200, 202. In some embodiments wherein pin 216 extends through pulleys 194, 196 and apertures 206, 208, mast 156 includes a spacer 205 positioned between pulley 194 and pulley 196 such that pulley 196 is spaced apart from pulley 194 by spacer 205, as shown in FIGS. 18 and 23, for example. In some embodiments, pulleys 194, 196 are rotatable relative to body and walls 200, 202 without a pin that extends through apertures in walls 200, 202.

Davit 32 includes a jib 210 extending along a longitudinal axis X3 between an end 212 and an opposite end 214. End 212 is pivotably positioned within cavity 204. In some embodiments, wall 200 includes an aperture 207 that is spaced apart from aperture 206 and wall 202 includes an aperture 209 that is spaced apart from aperture 208. Aperture 209 is aligned with aperture 207. End 212 includes a pathway that extends through a thickness of end 212 and is aligned with apertures 207, 209. In some embodiments, a pin 217 extends simultaneously through the pathway in end 212 and apertures 207, 209 to connect jib 210 to mast 156. In some embodiments, the pathway in end 212 includes a plurality of pathways, pin 217 includes a plurality of pins 217 and apertures 207, 209 include a plurality of apertures 207 and a plurality of apertures 209, pins 217 each extending simultaneously through one of the pathways in end 212, one of apertures 207 and one of apertures 209. Pin 217 defines a hinge configured to allow jib 210 to pivot relative to mast 156 to move jib 210 between a first orientation in which axis X3 extends transverse and/or perpendicular to axis X2 to a second orientation in which axis X3 extends parallel to axis X2, as discussed herein. In some embodiments, all or a portion of jib 210 is made from a strong, lightweight material, such as, for example, carbon fiber. That is, all or a portion of jib 210 consists of and/or comprises a strong, lightweight material, such as, for example, carbon fiber.

Jib 210 includes an inner surface 218 defining a channel 220. End 214 includes an opening 222 that is in communication with channel 220. Pulleys 224, 226 each have a first portion positioned in channel 220 and a second portion that extends through opening 222. Pulleys 224, 226 are rotatable relative to jib 210 in opposite first and second directions. In some embodiments, sections of portions 55, 65 are each enclosed within channel 220 such that rope 52 directly engages pulley 224 and rope 62 directly engages pulley 226. That is, surface 218 surrounds ropes 52, 62 360° about axis X3 along a maximum length of jib 210 defined by the distance from end 212 to end 214. Portions 55, 65 then exit channel 220 through opening 222. In some embodiments, opening 222 extends continuously from end 212 to end 214 such that ropes 52, 62 are not enclosed within channel 220. In some embodiments, channel 220 and/or opening 222 may have various cross section configurations, such as, for example, circular, oval, oblong, triangular, rectangular, square, polygonal, irregular, uniform, non-uniform, variable, tubular and/or tapered.

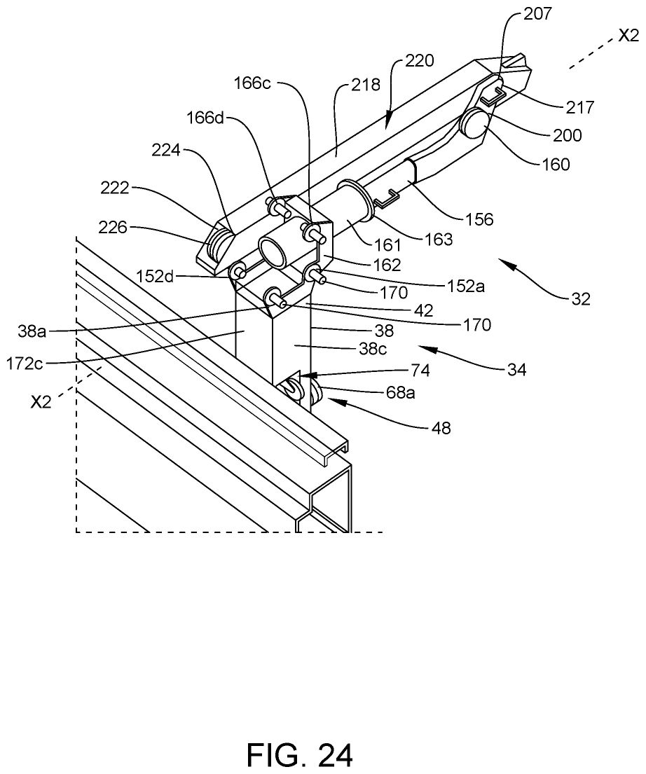

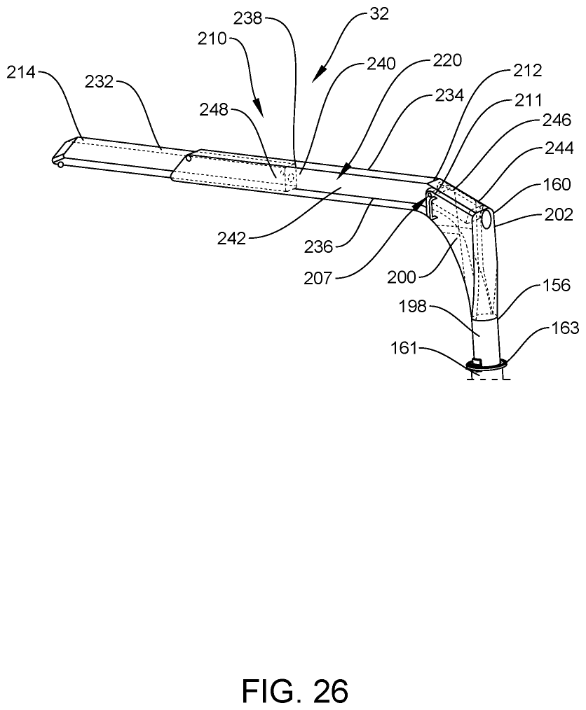

In some embodiments, jib 210 is telescopic and includes a screw system 228, as shown in FIG. 26, for example. Jib 210 is separated into an outer rail 230 and an inner rail 232. Inner rail 232 is movably positioned within a conduit 234 defined by an inner surface 236 of outer rail 230. An end surface of inner rail 230 includes a plate 238 positioned within conduit 234 such that plate 238 is movable relative to outer rail 230. Plate 238 is fixed to inner rail 232 and includes a threaded aperture 240. A threaded shaft 242 includes an end 244 that extends through an end surface 246 of end 212 and an opposite end 248 that extends through aperture 240 such that a male thread form of shaft 242 matingly engages a female thread form of aperture 240. End 244 is accessible for rotation by hand or by a tool, as shown in FIG. 24. Rotation of shaft 242 in a first rotational direction causes plate 238 to move away from end surface 246 to increase the length of jib 210 and rotation of shaft 242 in an opposite second rotational direction causes plate 238 to move toward end surface 246 to decrease the length of jib 210.

When davit 32 is operable to raise and lower platform 58 relative to roof R, mast 156 and axis X2 are parallel and/or coaxial with base 34 and axis X1 and jib 210 and axis X3 each extend transverse and/or perpendicular to axes X2, X3, as shown in FIG. 1, for example. Davit 32 supports platform 58 such that platform is positioned adjacent to building B to allow a contractor or service person to perform work and/or maintenance on building B. When the work and/or maintenance is completed, davit 32 can be transported to another location on roof R, to another roof of building B, or to another structure, such as, for example, another building.

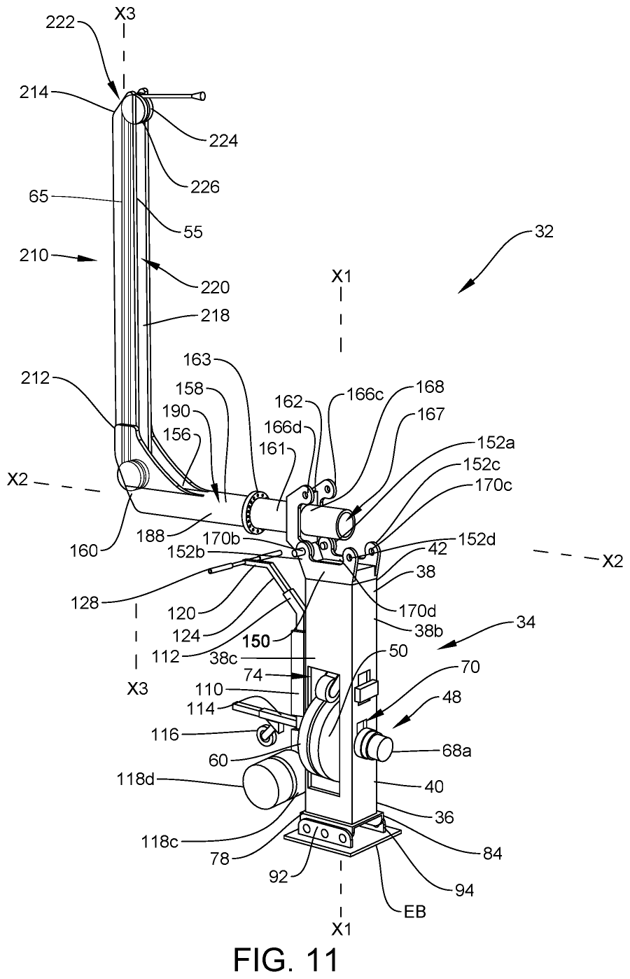

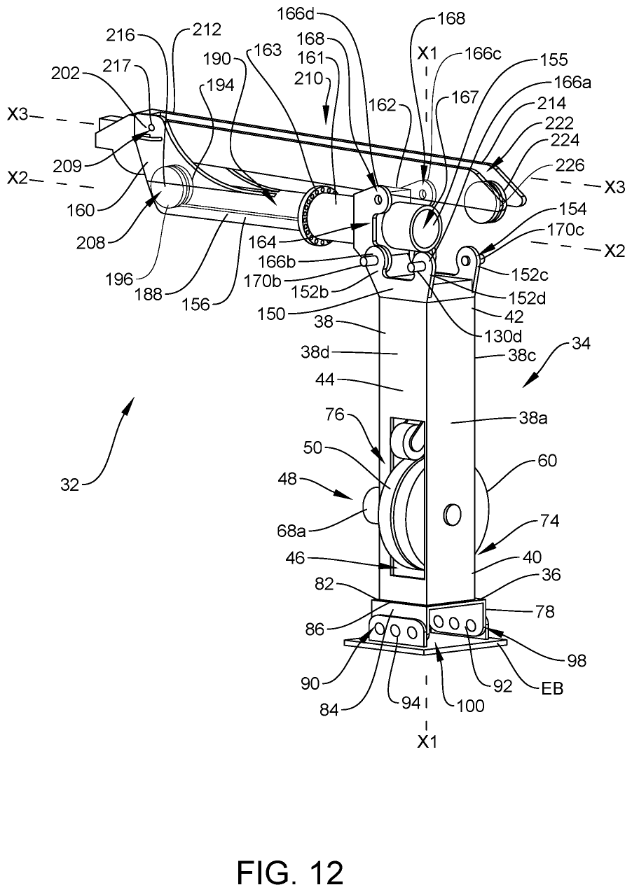

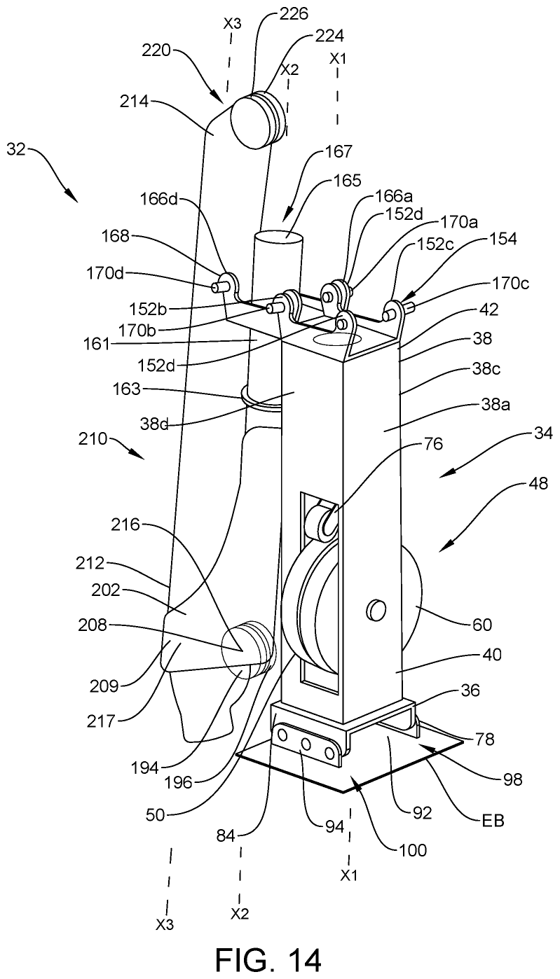

To prepare davit 32 for transport to another location, dowel 170c is removed from bore 154 of extension 152c and bore 168 of extension 166c and dowel 170d is removed from bore 154 of extension 152c and bore 168 of extension 166d and mast 156 and sleeve 161 are pivoted relative to base 34 from the first orientation in which axis X1 is parallel and/or coaxial with axis X2 to the second orientation in which axis X2 extends transverse and/or perpendicular to axis X1, as shown in FIG. 11. Jib 210 and axis X3 extend parallel to base 34 and axis X1, as also shown in FIG. 11. Next, jib 210 is pivoted relative to mast 156 about the hinge defined by pin 217 to pivot jib 210 relative to mast 156 to move jib 210 from the first orientation in which axis X3 extends transverse and/or perpendicular to axis X2 to the second orientation in which axis X3 extends parallel or substantially parallel to axis X2, as shown in FIG. 12. In some embodiments, the term “substantially parallel” refers to an angular relationship between zero degrees and five degrees and between about zero degrees and negative five degrees. In some embodiments, base 34 and axis X1 extend perpendicular to mast 156, jib 210 and axes X2, X3. Mast 156, sleeve 161 and jib 210 are then pivoted relative to base 34 from a first orientation in which axes X2, X3 extend perpendicular to axis X1 to a second orientation in which axes X2, X3 extend parallel or substantially parallel to axis X1, as shown in FIG. 14.

Next, base 34 is uncoupled from existing bracket EB by removing all but one of pegs 96 from flanges 78, 92 and removing all but one of pegs 96 from flanges 84, 94. Base 34 is then rotated relative to existing bracket EB about the one peg 96 that is inserted through flanges 78, 92 and the one peg 96 that is inserted through flanges 84, 94 such that axis X1 extends at angle α relative to roof R, as shown in FIG. 6. The one remaining peg 96 is removed from flanges 78, 92 and the one remaining peg 96 is removed from flanges 84, 94 such that base 34 can be lifted out of channels 98, 100 and removed from existing bracket EB. Base 34 can then be translated along roof R using wheels 116, 118 to move base from existing bracket EB to another location on roof R, such as, for example, another existing base that is the same or similar to existing bracket EB.

In particular, davit 32 is moved to another location that includes a building bracket that is the same or similar to existing bracket EB by tilting base 34 such that axis X1 extends at angle α relative to roof R, as shown in FIG. 6, and the majority of the weight of davit 32 is carried by wheels 116, 118. Wheels 116, 118 rotate relative to frame 104 to translate base 34 along roof R and position mounting portion 36 adjacent to existing base EB such that flange 78 is positioned within channel 98 and one of apertures 88 of flange 78 is aligned with one of holes 90 of flange 92. Two of apertures 88 of flange 78 are spaced apart from holes 90 of flange 92 such that only one aperture 88 of flange 78 is aligned with only one hole 90 of flange 92. One of pegs 96 is inserted into the aligned aperture 88 and hole 90 of flange 78 and flange 92. Mounting portion 36 is positioned relative to existing base EB such that flange 84 is positioned within channel 100 and one of apertures 88 of flange 84 is aligned with one of holes 90 of flange 94. Two of apertures 88 of flange 84 are spaced apart from holes 90 of flange 94 such that only one aperture 88 of flange 84 is aligned with only one hole 90 of flange 94. One of pegs 96 is inserted into the aligned aperture 88 and hole 90 of flange 84 and flange 94. Base 34 is then tilted relative to existing bracket EB such that axis L1 extends perpendicular to roof R, as shown in FIG. 2, and apertures 88 of flange 88 are each aligned with one of holes 90 of flange 92 and apertures 88 of flange 84 are each aligned with one of holes 90 of flange 94. One of pegs 96 is inserted into each of the aligned apertures 88 and holes 90 of flange 78 and flange 92. One of pegs 96 is inserted into each of the aligned apertures 88 and hole 90 of flange 84 and flange 94. Platform 58 and/or another platform that is the same or similar to platform 58 can be coupled to ends 56, 66 of ropes 52, 62 to allow contractors and/or servicepersons to perform work and/or maintenance on building B.

In some embodiments, base 34 can be pivoted relative to roof R after mounting portion 36 is dismounted from existing bracket EB. Base 34 can then be translated along roof R using wheels 94 to move davit 32 adjacent to the other mounting bracket of building B to couple mounting portion 36 to the other mounting bracket of building B, as discussed herein. Alternatively, davit 32 is movable between a first position in which axes X1, X2, X3 each extend transverse and/or perpendicular to roof R, to a second position in which axes X1, X2, X3 each extend parallel to roof R to facilitate carrying of davit 32 to the other mounting bracket of building B using only two people. Once davit 32 is positioned adjacent to the other mounting bracket of building B, base 34 can be pivoted relative to roof R to connect and/or align mounting portion 36 with the other mounting bracket of building B such that base 34 is fixed relative to the other mounting bracket of building B. Mast 156, sleeve 161 and jib 210 are then pivoted relative to base 34 from the first orientation in which axes X2, X3 extend parallel to axis X1 to the second orientation in which axes X2, X3 extend perpendicular to axis X1. Jib 210 is pivoted relative to mast 156 about the hinge defined by pin 217 to pivot jib 210 relative to mast 156 to move jib 210 from the second orientation in which axis X3 extends parallel to axis X2 to the first orientation in which axis X3 extends transverse and/or perpendicular to axis X2. Next, mast 156 and sleeve 161 are pivoted relative to base 34 from the second orientation in which axis X2 extends transverse and/or perpendicular to axis X1 to the first orientation in which axis X1 is parallel and/or coaxial with axis X2, as shown in FIG. 1. Platform 58 and/or another platform that is the same or similar to platform 58 can be coupled to ends 56, 66 of ropes 52, 62 to allow contractors and/or servicepersons to perform work and/or maintenance on building B.

In some embodiments, system 30 includes davit 32 and a davit 332 that is the same or similar to davit 32. Davit 332 is configured to work in conjunction with davit 32 to raise and/or lower platform 58, as discussed herein. In particular, davit 32 is coupled to an end 58a of platform and davit 332 is coupled to an opposite end 58b of platform 58 such that davit 32 and davit 332 simultaneously raise and/or lower platform 58. However, it is envisioned that this arrangement can be reversed such that davit 32 is coupled to end 58b of platform and davit 332 is coupled to end 58a of platform 58.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A portable davit comprising:
a base comprising a mounting portion and a housing coupled to the mounting portion, the housing comprising an inner surface defining a cavity;
a hoist positioned within the cavity, the hoist comprising a drive and a rope, the rope including opposite first and second ends, the first end of the rope being wound about the drive;
a mast comprising opposite first and second ends, the first end of the mast being positioned within the cavity, the mast comprising an inner surface defining a passageway; and
a jib including opposite first and second ends, the first end of the jib being coupled to the second end of the mast, the second end of the rope extending through an opening in the second end of the jib.

2. The portable davit recited in claim 1, wherein at least one of the mast and the jib is made from carbon fiber.

3. The portable davit recited in claim 1, wherein the rope comprises an intermediate portion between the first end of the rope and the second end of the rope, the jib comprising an inner surface defining a channel, the passageway being in communication with the cavity and the channel being in communication with the passageway such that the intermediate portion of the rope extends through the passageway and the channel.

4. The portable davit recited in claim 3, wherein the intermediate portion of the rope is enclosed within the passageway and the channel.

5. The portable davit recited in claim 1, wherein the hoist is a drum hoist.

6. The portable davit recited in claim 1, wherein the jib is pivotable relative to the mast.

7. The portable davit recited in claim 1, wherein the jib is pivotable relative to the mast between a first orientation in which the jib extends transverse to the mast and a second orientation in which the jib extends parallel to the mast.

8. The portable davit recited in claim 1, wherein the jib is telescopic.

9. The portable davit recited in claim 1, wherein the jib comprises a screw system configured to increase and decrease a length of the jib.

10. The portable davit recited in claim 1, wherein the mast is pivotable relative to the base about a hinge between a first orientation in which the mast extends parallel to the base and a second orientation in which the mast extends transverse to the base.

11. The portable davit recited in claim 1, wherein the mounting portion is configured to be mounted to a davit base, the davit base being mounted to a building.

12. The portable davit recited in claim 1, wherein the mounting portion comprises a plurality of wheels configured to engage a surface to move the base along the surface.

13. The portable davit recited in claim 1, wherein the base is movable between a first orientation in which an axis defined by the base extends perpendicular to a surface and a second orientation in which the base is tilted relative to the surface such that the axis extends transverse to the configured to engage a surface to move the base along the surface.

14. The portable davit recited in claim 13, wherein the base comprises a plurality of wheels, the wheels being spaced apart from the surface when the base is in the first orientation, the wheels directly engaging the surface when the base is in the second orientation.

15. The portable davit recited in claim 1, wherein the mounting portion comprises spaced apart flanges, the flanges each including a plurality of apertures, the apertures being configured for alignment with holes of a davit base, the portable davit comprising a plurality of pegs, the pegs each being configured to extend through one of the apertures that is aligned with one of the holes to fix the base to the davit base.

16. The portable davit recited in claim 1, further comprising a platform coupled to the second end of the rope.

17. The portable davit recited in claim 16, wherein at least one of the base, the mast, the jib and the platform is made from carbon fiber.

18. The portable davit recited in claim 1, wherein the drive is configured to rotate relative to the housing in a first direction to decrease a distance between the platform and the second end of the jib and to rotate relative to the housing in an opposite second direction to increase the distance between the platform and the second end of the jib.

19. A portable scaffold davit comprising:
a base comprising a mounting portion and a housing coupled to the mounting portion, the housing comprising an inner surface defining a cavity;
a first bracket coupled to the base;
a hoist positioned within the cavity, the hoist comprising a drive and a rope, the rope including opposite first and second ends, the first end of the rope being wound about the drive;
a sleeve positioned within the cavity;
a second bracket coupled to the sleeve;
a mast including opposite first and second ends, the first end of the mast being coupled to the sleeve, the mast comprising an inner surface defining a passageway; and
a jib including opposite first and second ends, the first end of the jib being coupled to the second end of the mast, the second end of the rope extending through an opening in the second end of the jib,
wherein a pin extends through the first bracket and the second bracket, the pin defining a hinge configured to allow the mast to pivot relative to the base.

20. A portable scaffold davit comprising:
a base comprising a mounting portion and a housing coupled to the mounting portion, the housing comprising an inner surface defining a cavity;
a drum hoist removably positioned within the cavity, the drum hoist comprising a drive and a rope, the rope including opposite first and second ends, the first end of the rope being wound about the drive;
a mast including opposite first and second ends, the first end of the mast being positioned within the cavity, the mast comprising an inner surface defining a passageway, the mast being pivotable relative to the base about a hinge between a first orientation in which the mast extends parallel to the base and a second orientation in which the mast extends transverse to the base;
a jib including opposite first and second ends defining a length of the jib, the first end of the jib being coupled to the second end of the mast, the second end of the rope extending through an opening in the second end of the jib, the jib comprising a screw system configured to increase and decrease the length of the jib, the jib being pivotable relative to the mast between a first orientation in which the jib extends transverse to the mast and a second orientation in which the jib extends parallel to the mast; and
a platform, the second end of the rope being coupled to the platform,
wherein the mast and the jib are made from carbon fiber.
